(19) United States
(12) Patent Application Publication
(10) Pub. No.: US 2016/0086128 A1
(43) Pub. Date: Mar. 24, 2016

(54) SYSTEM AND METHOD FOR ON-DEMAND TRANSPORTATION OF PARCELS

(71) Applicant: Fetch1 Transport LLC, Littleton, CO (US)

(72) Inventors: Edwin Troy Geiger, Littleton, CO (US); Bryan Kopp, Littleton, CO (US); William Anthony DeCrescenzo, Littleton, CO (US); Joe Harker, Littleton, CO (US)

(73) Assignee: Fetch1 Transport LLC, Littleton, CO (US)

(21) Appl. No.: 14/859,148

(22) Filed: Sep. 18, 2015

Related U.S. Application Data
(60) Provisional application No. 62/052,337, filed on Sep. 18, 2014.

(51) Int. Cl. G06Q 10/06; G06Q 10/08

(52) U.S. Cl. CPC G06Q 10/063118; G06Q 10/0833

(57) ABSTRACT

The invention described herein is a system and method for on-demand transportation of parcels in real time. The system and method described herein automate the process of locating local parcel carriers, typically driving vehicles, and engaging one of those parcel carriers to pick up a parcel from a given location and delivering the parcel to a particular destination location in real time based on a predetermined cost of delivery and payment for the delivery.

### CROSS-REFERENCE TO RELATED APPLICATIONS

This US non-provisional patent application claims benefit and priority to U.S. provisional patent application No. 62/052,337 filed on Sep. 18, 2014, titled “METHOD AND SYSTEM FOR TRANSPORTING PARCELS”, the contents of which are incorporated by reference as if fully set forth herein.

### BACKGROUND OF THE INVENTION

1. Field of the Invention

This invention relates generally to systems and methods for transporting parcels from one location to another. More particularly, this invention relates to systems and methods for on-demand transportation of parcels.

2. Description of Related Art

The need to transport documents or parcels from one location to another is an ongoing need for businesses and individuals alike. Conventional systems for transporting parcels from one location to another are well-known in the art. For example in the US, the United States Postal Service® (USPS) provides conventional letter carrying as well as parcel delivery service allowing its customers to send letters and packages to virtually any mailing address in the world. The USPS has numerous courier service competitors, e.g., Federal Express® (FEDEX), United Parcel Service® (UPS) and DHL Express® (DHL) and many others. These global courier services all provide similar parcel transportation services using fleets of trucks and airplanes to transport packages from one location to another potentially distant location.

Courier services may be distinguished from conventional mail services by various service features, e.g., quick delivery, security, package tracking, signature receipt, for costs that that are usually more expensive than standard mail services. Thus, courier services are normally limited to packages where one or more the above-listed features are considered important enough to justify the added cost. On a smaller local scale, courier services may provide transportation of parcels using employ bicycle and motorcycle transportation for shorter point-to-point delivery of small parcels.

Shortcomings with global courier services include expensive service and lack of quick delivery, e.g., they typically can only guarantee overnight delivery as their fastest mode of delivery. What if you want your package delivered in the next hour? Conventional local scale courier services can offer same-day delivery, but also have shortcomings, e.g., bicycle couriers are limited by size and distance in which they operate, and even motorcycle couriers are effectively limited in the size of parcels they can deliver as well as delivery range. Accordingly, there is still room for improving the art of delivering parcels.

### SUMMARY OF THE INVENTION

An embodiment of a method for on-demand delivery of parcels is disclosed. The method may include providing a server with server software configured for communicating with smartphones. The method may further include providing downloadable application software for installation and execution on the smartphones. The method may further include a subscribed driver having downloaded and installed the application software on a driver smartphone. The method may further include a user having downloaded and installed the application software on a user smartphone.

The method may further include the user initiating a request to deliver a parcel having delivery particulars where the request is sent to the server. The method may further include the server alerting the subscribed driver of the request to deliver the parcel, its delivery particulars and cost to deliver. The method may further include the subscribed driver accepting the request to deliver the parcel. The method may further include the subscribed driver retrieving the parcel from a pickup address. The method may further include the subscribed driver delivering the parcel to the delivery address. The method may further include the subscribed driver providing proof of delivery to the server. The method may further include the server alerting the user that the parcel has been delivered. The method may further include the user acknowledging delivery of the parcel. The method may further include the server making payment to the subscribed driver.

An embodiment of a system for on-demand delivery of parcels is disclosed. The system may include a server having associated server software installed and running. The server may be configured for communicating with mobile smartphones through at least one cellular data network. The system may further include a user smartphone having associated application software installed, running and in communication with the server. The system may further include a plurality of driver smartphones each having the associated application software installed, running and in communication with the server. The system may further include a payment processor in communication with the server, user smartphone and the plurality of driver smartphones and the payment processor configured for verifying, holding and dispersing user payments from a user to associated driver accounts and a server merchant account.

The system may further include the user smartphone being configured to gather delivery particulars for a delivery need and to submit the particulars to the server. The system may further include the server being configured to calculate a cost of delivery and return the cost of delivery to the user smartphone. The system may further include the user smartphone being configured to submit payment based on the cost of delivery to a holding account at the payment processor. The system may further include the payment processor being configured to advise the server of the user payment having been submitted. The system may further include the server being configured to alert the plurality of driver smartphones regarding: (1) the delivery need, (2) the delivery particulars and (3) the payment for delivery.

The system may further include one of the plurality of driver smartphones submitting to the server an offer to drive. The system may further include the server alerting the user smartphone of the offer to drive. The system may further include the one of the plurality of driver smartphones continuously posting driver smartphone location to the server. The system may further include the server updating driver location information and sending same to the user smartphone. The system may further include the user smartphone configured to display the location of the driver, the pickup address and delivery address for viewing. The system may further include the one of the plurality of driver smartphones posting a delivery signature or delivery photo to the server to confirm delivery. The system may further include the server configured to authorize the payment processor to make payment for delivery. The system may further include the payment processor being configured to pay the driver account for delivery, less a server fee placed in the server merchant account and the payment processor confirming payments made to the server. The system may further include the server being configured to alert the user smartphone of delivery completion.

Additional features and advantages of the invention will be set forth in the description which follows, and in part will be apparent from the description, or may be learned by the practice of the present invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is an image of a portion of an exemplary smartphone display from a smartphone showing an exemplary icon for engaging the method and system for parcel delivery services, according to the present invention.

FIG. 2 is an exemplary graphical user interface for a “Welcome” page according to the present invention.

FIG. 3A is an exemplary GUI for a “MY DELIVERY INFORMATION” blank page 120 according to the present invention.

FIG. 3B is an exemplary GUI for a “MY DELIVERY INFORMATION” page that has been fully populated with package size (medium selected), pickup and delivery address entered, delivery mileage calculated and displayed, contents description, weight and special instructions entered according to the present invention.

FIG. 4 is an exemplary GUI for a delivery verification page, according to and embodiment of the present invention.

FIG. 5 is an exemplary GUI for a payment window overlay used to gather necessary information from the user for payment processing, according to an embodiment of the present invention.

FIG. 6 is an exemplary GUI of a map page including a map where the pickup and delivery addresses and driver are all marked with placement pins, according to an embodiment of the present invention.

FIG. 7 is an exemplary GUI for an optional rating page, according to an embodiment of the present invention.

FIG. 8 is an exemplary GUI of a Stripe® overlay showing the Stipe® login page which gives a user or driver access to his/her Stripe® account, according to an embodiment of the present invention.

FIG. 9 is an exemplary GUI of the Stripe® welcome back page, according to an embodiment of the present invention.

FIG. 10 is an exemplary GUI for of an available pickups page, according to an embodiment of the present invention.

FIG. 11 is an exemplary GUI for of deliver information page, according to an embodiment of the present invention.

FIG. 12 is an exemplary GUI illustrating a driver navigation page, according to an embodiment of the present invention.

FIG. 13 is an information flow diagram illustrating how an embodiment of the system of the present invention operates.

FIG. 14 is a block diagram of a generic embodiment of a system for on-demand transportation of parcels, according to the present invention.

FIG. 15 is a block diagram of a generic user/driver of the system and method, according to an embodiment of the present invention.

### DETAILED DESCRIPTION

The invention described herein is a system and method for transporting parcels that automates the process of locating local parcel carriers, typically driving vehicles, and engaging one of those parcel carriers to pick up a parcel from a given location and delivering the parcel to a particular destination location in real time. Among the particularly useful features of the method of the present invention is that the parcel to be delivered may be categorized by size and weight so that the parcel carrier may be properly select or match his or her vehicle for the particular delivery. Another useful feature is that payment is authorized, validated and disbursed in real time.

The application described herein allows a user to select a driver to move anything from small parcels to large freight items within minutes. Aspects of the invention are similar to the ride share technology that is currently used to move people. However, key features are distinctly different and tailored to moving packages and products. A user of the system described here obtains instant access to an efficient and streamlined process for moving goods without significant delay. Delivery drivers may be displayed in real time according to one embodiment. Users simply choose a method of delivery and select the nearest driver to respond to the user's needs. The process described takes place instantly, not in three to five days like conventional parcel delivery services. Within minutes the user has their package in transit to its destination.

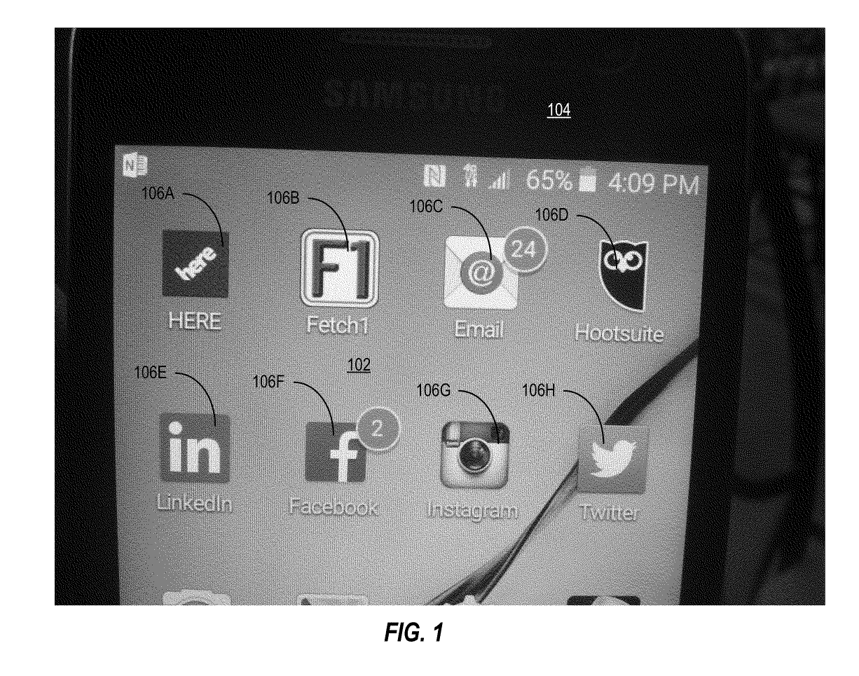

The system and method of the present invention may be implemented in a number of ways, for example and not by way of limitation, a smartphone application. The term “application” as used herein refers to a computer program (software) that executes on a computer system (hardware), for example a smartphone. One advantage of using a smartphone application (APP) to implement the system and method of the present invention is that both users and drivers will likely have a smartphone and, thus, access to the application. Another advantage is that smartphones in combination with their associated cellular voice and data networks provide the infrastructure to implement the system and method described herein. An exemplary APP, referred to herein as the “Fetch 1 APP”, or “F1 APP”, that implements one embodiment of the system and method is described herein with reference to FIGS. 1-12.

We begin with a high-level description of how a particular embodiment of the method and system as implemented in the form of a smartphone APP in combination with server software operating on a cellular broadband (voice and data) network. The description begins from the “customer” or “user” perspective. The user wants a package or parcel delivered using the system. First, the user downloads and installs the APP onto their smartphone. Downloading and installing the APP may be performed from the smartphone by connecting to the appropriate applications store, e.g., Google Play® for Android® phones or iTunes® for Apple iOS® phones, as is well known to most anyone. The user will build a profile including contact information, email address, etc. for billing purposes and also link a credit card to a payment processing account. Any suitable mobile payment processing service provider such as Stripe® (stripe.com), PayPal® (paypal.com), Braintree® (braintreepayments.com), Square, Inc. (squareup.com), Adyen® (adyen.com), or conventional merchant banking could be used for payment processing in accordance with the teachings of the present invention. For exemplary convenience and not by way of limitation a Stripe® account is used as the payment processing service provider described herein.

Once the user profile and credit card information is completed and submitted the information is then verified by the Stripe® system confirming that payment processing can be completed once initiated. A verification email is then sent back to the user's email that will have a link to verify the account. The user simply clicks on that link to complete the verification (including correct email address). Setting up a Stripe® account, linking a credit card and verifying the account are all within the knowledge of one of ordinary skill in the art, and thus will not be further elaborated herein. Once this verification is complete, the user can immediately use the system and method of the present invention.

Referring now to FIGS. 1-6 the process of using the APP will now be described with reference to an exemplary embodiment of the invention. FIG. 1 is an image of a portion of an exemplary smartphone display 102 from a smartphone 104 showing an exemplary icon 106B for engaging the method and system for parcel delivery services, according to the present invention. The user opens the APP by selecting the Fetch1 (F1) APP icon 106B on their smartphone display 102, see FIG. 1.

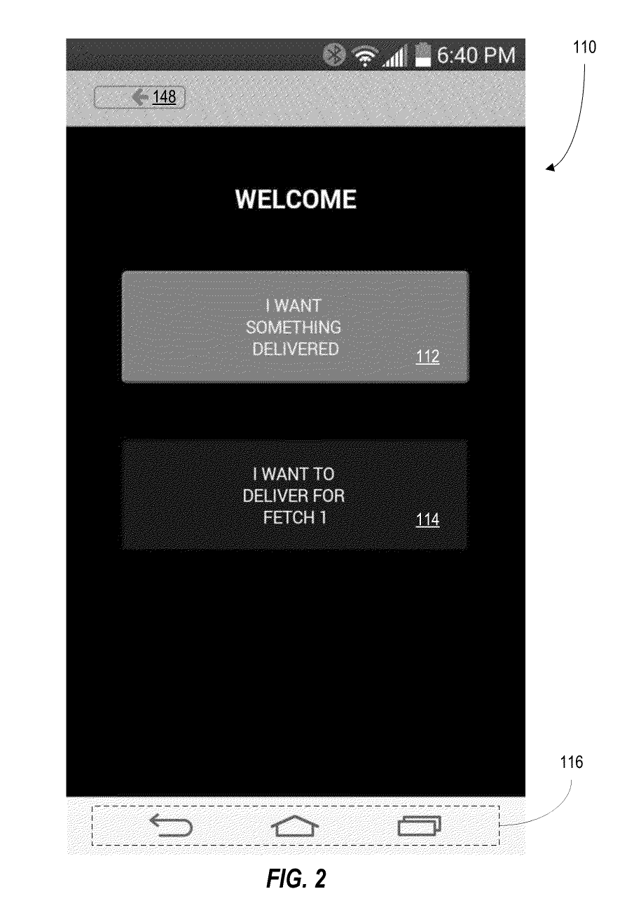

The user is then taken to the Welcome page 110, see FIG. 2. FIG. 2 is an exemplary graphical user interface (GUI) for a “Welcome” page 110 according to the present invention. From the Welcome page 110 the user has the option of selecting: (1) the “I WANT SOMETHING DELIVERED” button 112 as a user of the service, or (2) the “I WANT TO DELIVER FOR FETCH 1” button 114 as a driver for delivering parcels in the system and method of the present invention. The optional Android® navigation icons (back, home and recent), shown in dashed box 116 of FIG. 2 may be present on various screen view in APP embodiments ported to the Android® operating system. Such navigation icons 116 may, of course, not be present in Apple iOS® embodiments of the APP. Though useful for navigating smartphone applications and features of the smartphone, such navigation icons 116 are not part of the present invention.

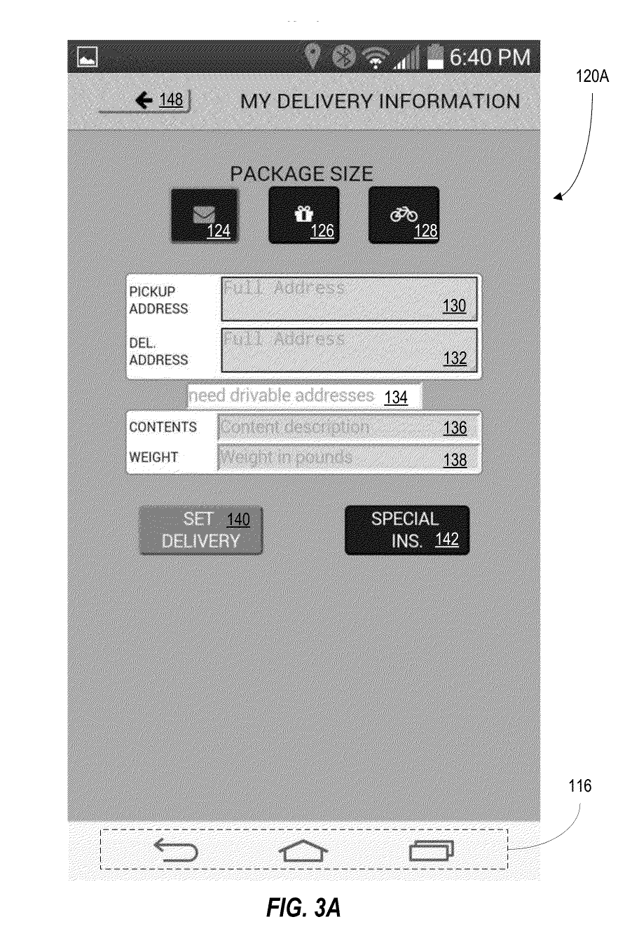

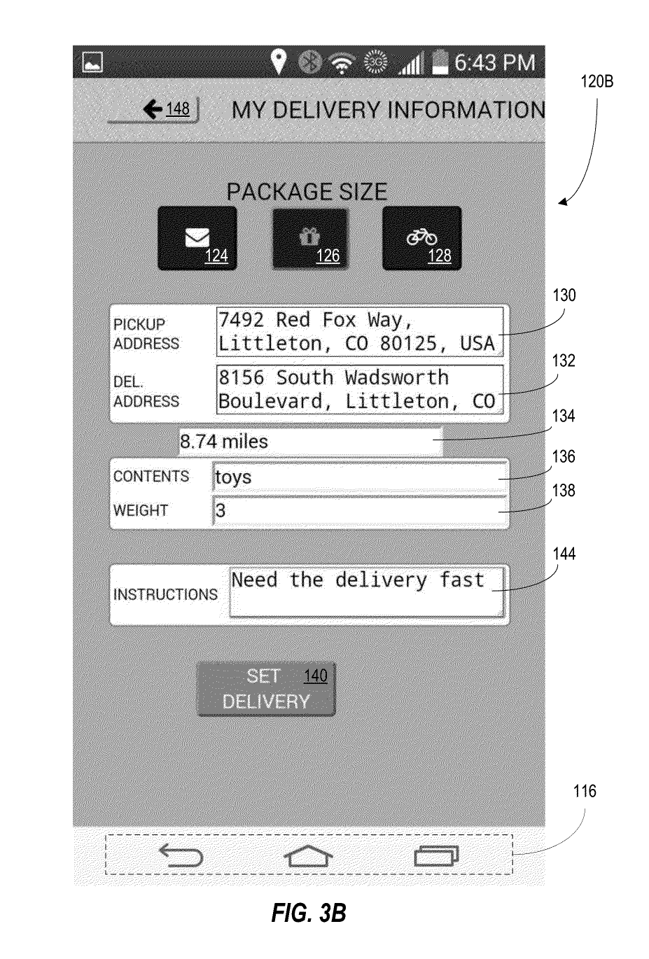

By selecting the “I WANT SOMETHING DELIVERED” button 112 as a user of the service, the user is then directed to the “MY DELIVERY INFORMATION” page 120A, where the user is prompted to enter the parcel delivery particulars, see FIG. 3A. FIG. 3A is an exemplary GUI for a “MY DELIVERY INFORMATION” blank page 120A according to the present invention. The parcel deliver particulars may include package size, pickup address, delivery address, contents or description of the parcel, weight of the parcel and an optional “special instructions” field that the user can edit and send to the driver who will deliver the parcel. Accordingly, on the “MY DELIVERY INFORMATION” blank page 120A, the user will find a place to choose the size of the package, add the pickup address, a delivery address, contents, weight, and a section for special instructions for the transaction.

An important aspect of the parcel delivery particulars relates to the size of the parcel. Since virtually any size parcel could be delivered using the system and method of the present invention, a convenient way of categorizing general size of the parcel is particularly useful. Three button icons 124, 126, 128 shown underneath the “PACKAGE SIZE” indicia 122 allow the user to quickly select small 124, medium 126 or large 128 package size by referencing the graphics on the small 124, medium 126 and large 128 button icons. So, the user simply selects one of the three button icons 124, 126, 128 as it best reflects the size of the package that he or she wants delivered. The particular button selected may be highlighted to indicate its having been selected, see the highlighting on the small package icon button 124 in FIG. 3A. It will be understood that the three size categories of small, medium and large are merely representative and not limiting of the present invention. Any number of sizes or method of categorizing the package size may be used consistent with the present invention. The system and method of the present invention is not limited by the particular contents of a “parcel” to be delivered. Thus, it is contemplated that package size or handling tiers for freight, alcohol, pharmaceuticals, important documents, even temperature controlled goods are also within the scope of “parcels” that could be delivered using the system and method of the present invention.

Blank page 120A also has fields allowing the user to populate the pickup address 130 and the delivery address 132. These addresses may be used by navigation and mapping software resident on the smartphone to graphically indicate on a map the locations of the pickup and delivery addresses. Thus, the addresses need to be navigable with conventional navigation and mapping software application resident on the smartphones being used.

An embodiment of the system of the present invention automatically calculates the actual miles from pickup address 130 to delivery address 132 using the shortest route and the mileage is displayed in the center of the screen in a calculated delivery mileage field 134. The user may also add any special instructions necessary to inform the delivery driver of special handling requirements such as but not limited to do not bend, fragile, heavy, etc., by selecting the “SPECIAL INS.” (special instructions) button 142. For all pages after the Welcome page 110, a back page button 144 is activated to allow navigating backward through the pages within the APP. Forward movement through the pages is generally achieved serially and with other action buttons as described herein. Note that in the embodiments shown here, the back page button 144 is deactivated on the Welcome page 110 because it is the first and starting page for the APP. The deactivated nature of the back page button 144 on the Welcome page 110 may be indicated by a lighter font as shown on FIG. 2.

It will be understood that where appropriate, ghost prompts for user-supplied information may be displayed in any empty user-fillable field according various embodiments of the present invention. For example as shown in FIG. 3A, the ghost prompt shown in the pickup address field is “Full Address”, which is also used in the delivery address field 132. Similarly, the ghost prompt “Content description” may be displayed in the contents description field 136, the ghost prompt “Weight in pounds” may be displayed in the weight in pounds field 138. The calculated delivery mileage field 134 is not user-fillable as it is automatically calculated based on the pickup and delivery addresses. But, field 134 may also have a ghost prompt, such as “need drivable addresses” which is a further ghost prompt directed to the contents of related fields 130 and 132. All of these ghost prompts are configured to disappear once actual information is entered into those fields for display. These ghost prompts may be displayed in a lightly shaded text font, according to yet another embodiment of the present invention.

FIG. 3B is an exemplary GUI for a “MY DELIVERY INFORMATION” page 120B that has been fully populated with package size (medium selected/highlighted), pickup and delivery address entered, delivery mileage calculated and displayed, contents description, weight and special instructions entered according to the present invention. Note that by selecting the “SPECIAL INS.” button 142 from page 120, a special instructions field 144 is automatically displayed and the user is prompted to enter the desired special instructions into field 144, for example “Need the delivery fast” as shown in FIG. 3B.

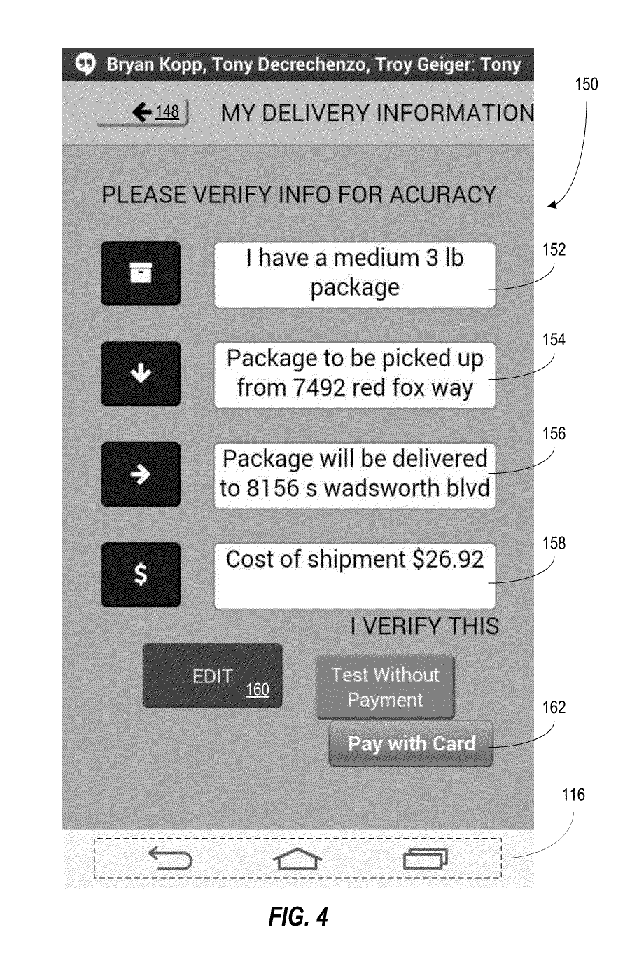

After all of the delivery particulars information is entered on page 120B (FIG. 3B) the user proceeds by selecting the “SET DELIVERY” button 140. After the “Set Delivery” selection is made, the user is taken to the delivery verification page 150, see FIG. 4. FIG. 4 is an exemplary GUI for a delivery verification page 150, according to and embodiment of the present invention. On the delivery verification page 150, the size and weight of the package are displayed in the size and weight summary field 152, the pickup address is displayed in the pickup address summary field 154, the delivery address is displayed in the delivery address summary field 156, and the cost of the shipment is displayed in shipment cost summary field 158. If any information is incorrect the user can select the “EDIT” button 160 and will be taken back to previously populated “MY DELIVERY INFORMATION” page 120B to make necessary changes and then again select the “SET DELIVERY” button 140. If the user verifies the information is correct and agrees to cost of shipment, the user then selects “PAY WITH CARD” button 162. The “Test Without Payment” button shown in FIG. 4 is a test feature used during beta prototyping of the App and is not a final feature of the invention, and thus can be ignored for the purposes of this disclosure.

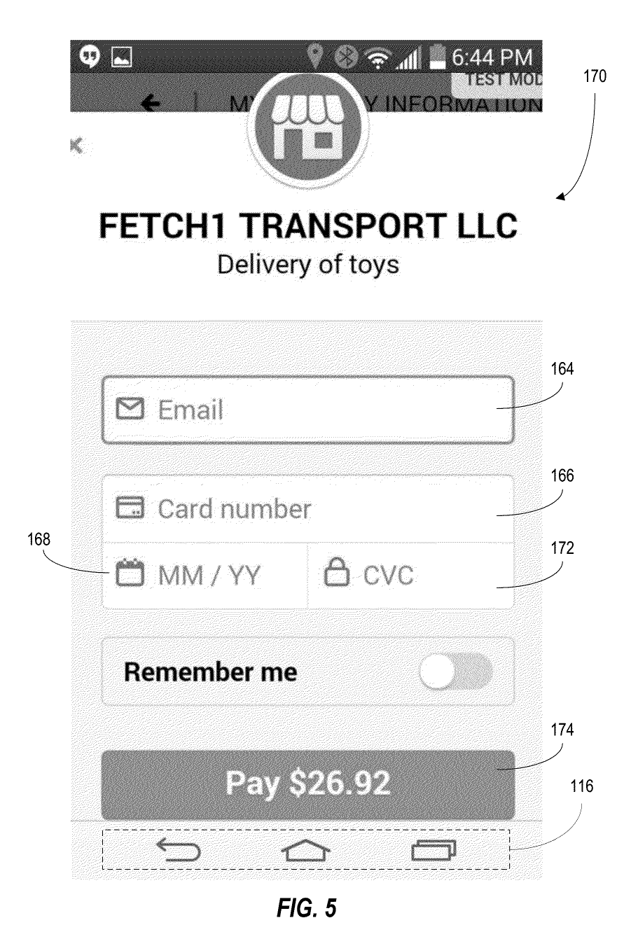

After the “PAY WITH CARD” button 162 selection is made by the user, the App displays a payment window overlay 170, see FIG. 5. FIG. 5 is an exemplary GUI for a payment window overlay 170 used to gather necessary information from the user for payment processing, according to an embodiment of the present invention. As noted previously, the payment processing used in this particular embodiment is supplied by Stripe® (stripe.com), San Francisco, Calif. However, it will be understood and any other suitable payment processing system or service (such as those discussed herein) could be used consistent with the teachings of the present invention. The payment window overlay 170 requires the user to fill in payment information fields their email address 164, credit card number 166, expiration date 168, and card verification code (CVC) 172.

Once this payment information is entered into the appropriate payment information fields 164, 166, 168 and 172 the user selects “Pay” button 174 on the payment window overlay 170 to make the payment. Note that the “Pay” button 174 displays the amount to be paid ($26.92 as shown on FIG. 5) prior to being selected. Once the “Pay” button 174 is selected in the payment window overlay 170, third party payment processing occurs. In this particular example, a Stripe® server verifies the credit card information and funds are placed in escrow in a merchant account.

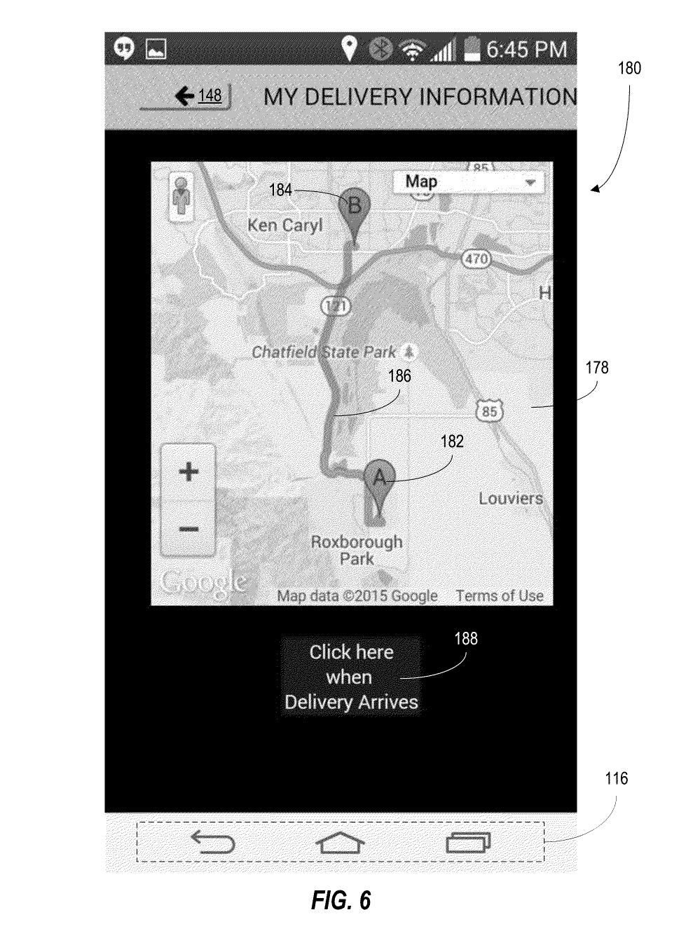

After payment is processed, a “delivery needed alert” is sent out to subscribed drivers via cellular or wireless data networks (not shown) and the user is taken to the “Map” page 180 by the App, see FIG. 6. FIG. 6 is an exemplary GUI of a map page including a map 178 where the pickup and delivery addresses and driver location (pin C, not shown in FIG. 6), respectively are marked with placement pins A and B, respectively, according to an embodiment of the present invention. More particularly, pin “A” marks the driver location 182, pin “B” marks pickup address 184 and pin “C” (not shown in FIG. 6) marks the delivery address. The shortest route 186 between the driver location 182 (pin A) and the parcel pickup address 184 (pin B) may be displayed as a bolded line connecting pins A and B. The user can observe the delivery driver 182 (pin A) making progress to the pickup location 184 (pin B) and delivery location (pin c, not shown) and observe the progress of the delivery being made in real time.

Once the driver delivers the package, the driver will gather a signature or photo confirming delivery then posts it to the Fetch1 server. Gathering the signature or photo confirming delivery may be mechanized through taking a photograph using the driver's smartphone camera, or by capturing a delivery signature using an appropriate third party App, according to various embodiments of the system and method of the present invention. Posting the signature or photo confirming delivery may be mechanized by sending an email, text, or other communication including the signature or photo confirming delivery to the Fetch 1 server, according to various embodiments of the system and method of the present invention. The Fetch 1 server then alerts the user that the package has been successfully delivered. This alert may be in the form of a text, email, or other indicator within the map page 180 (none shown in FIG. 6), according to various embodiments of the system and method of the present invention. The driver is held at the waiting for the user to accept delivery confirmation by engaging the “Click here when Delivery Arrives” button 188.

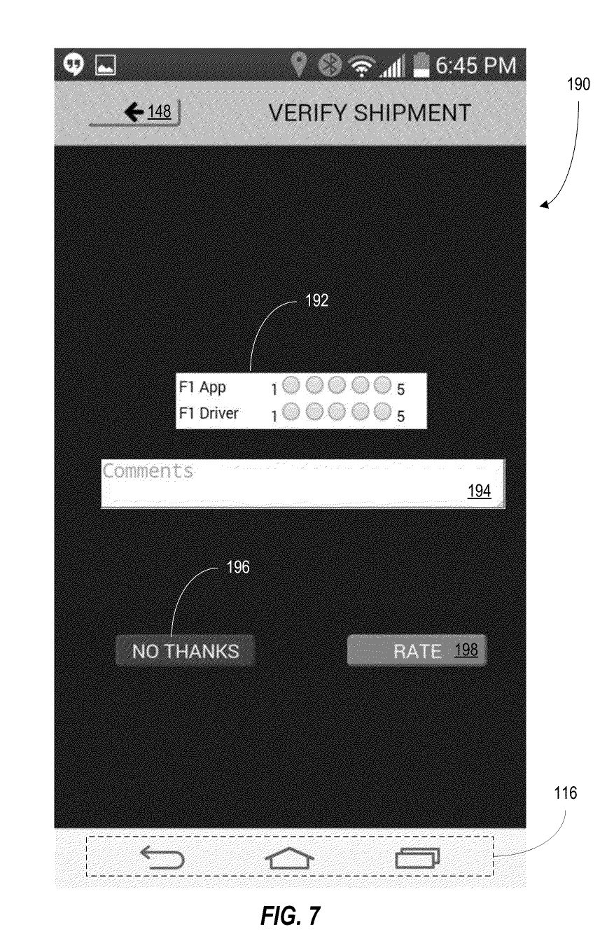

According to one particular embodiment the driver's posting of the signature or photo delivery confirmation (1) will trigger a message confirming delivery which is sent back to the user, (2) the user acknowledges receipt of the confirming message by engaging the “Click here when Delivery Arrives” button 188, (3) the Fetch 1 server receives that acknowledgement and directs the Stripe® server to release the funds from escrow in the merchant account to the driver minus APP usage fees, and finally (3) both the user and the driver are directed to the “rating” page 190, see FIG. 7.

FIG. 7 is an exemplary GUI for an optional rating page 190, according to an embodiment of the present invention. The rating page 190 gives the user the option to rate the APP and/or the driver using the App and driver ratings field 192, or to exit the APP by selecting the “NO THANKS” button 196. If the user selects the no thanks button 196, the user is directed back to the welcome page 110, see FIG. 2. Alternatively, if the user desires to leave a rating, the user can select the desired rating of one through five as desired for either the APP or the driver or both, according to one embodiment of the system and method of the present invention. The ratings may be based on a range from one being poor up to five being outstanding. It will be understood that any suitable ratings scale could be employed consistent with the teaching of the present invention. The user also has the option of providing comments in a comments field 194. Once the user selects the desired rating(s), they select the “RATE” button 198 and the user is directed back to the Welcome page 110, see FIG. 2. The rating(s) and comments, if any, may be sent to the Fetch 1 server to build up a database of ratings for the APP and the driver and also to provide feedback for improving the service, according to one embodiment of the system and method of the present invention.

Now that the method and system of the present invention has been described from the perspective of a user desiring to have a package delivered, the driver's perspective will now be described. As an initial matter, the driver first needs to install the Fetch 1 (F1) APP by downloading and installing the APP onto their smartphone. Downloading and installing the APP may be performed from the smartphone by connecting to the appropriate applications store, e.g., Google Play® for Android® phones or iTunes® for Apple iOS® phones, as is well known.

The driver will be required to set up an account in a payment processing service. Again, for example's sake, we will assume the payment processing service is provided through Stripe® (stripe.com). Within a Stripe® overlay (not shown) the driver can build a profile and link a credit card to a Stripe® account. The information is then verified by the Stripe® system. Then a verification email is sent back to the driver's email that will have a link to verify the account. Setting up a Stripe® account, linking a credit card and verifying the account are all within the knowledge of one of ordinary skill in the art, and thus will not be further elaborated herein. Once this verification is complete, the driver can immediately use the system and method of the present invention.

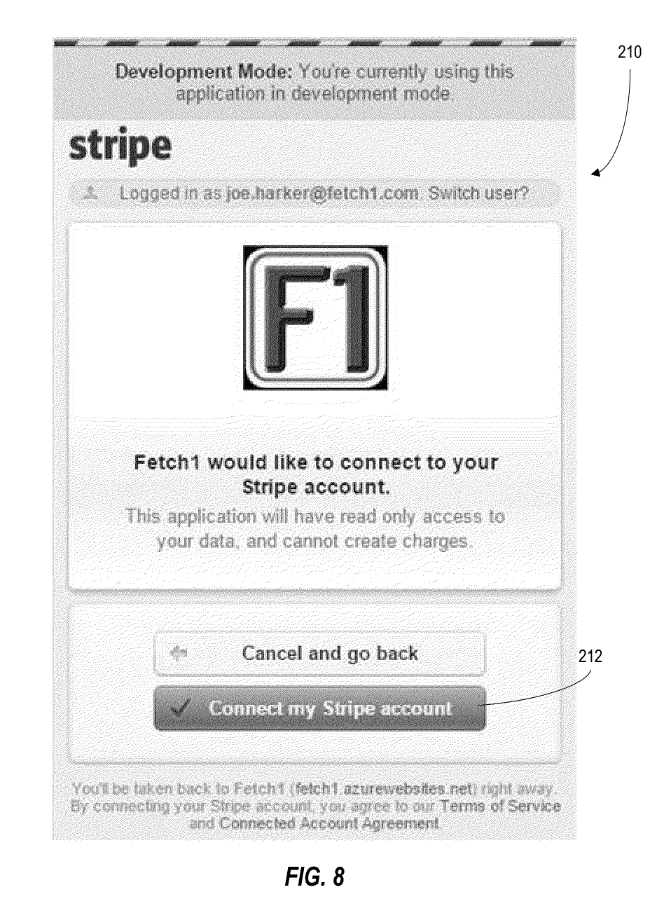

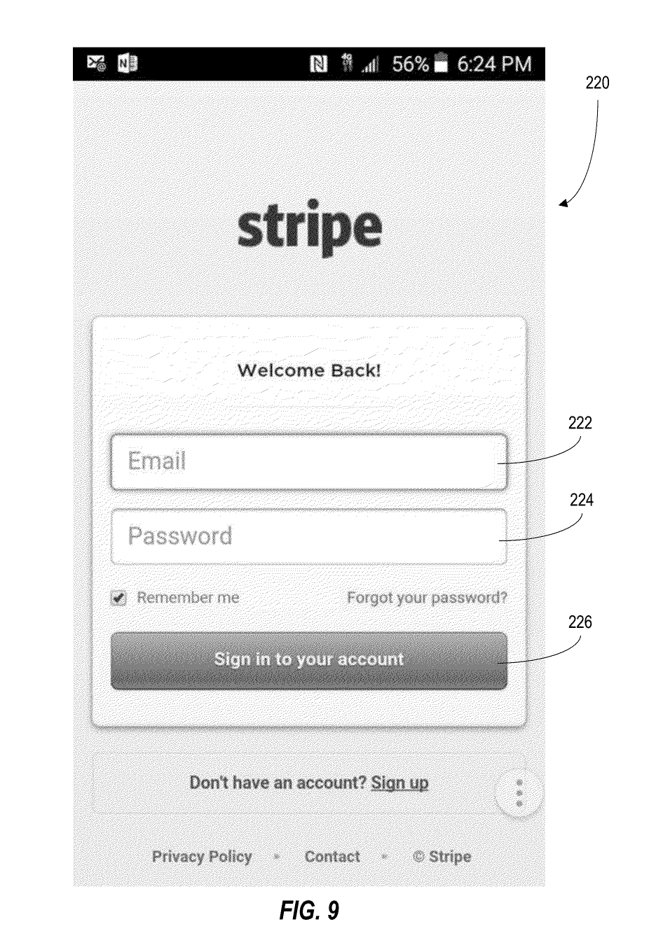

The driver begins using the system and method of the present invention by clicking on the F1 icon 106B, FIG. 1. After the driver opens the APP by selecting the F1 icon 106B on their smartphone, the driver is taken to the Welcome page 110, FIG. 2 where the driver has the option of selecting the “I want something delivered” button 112, or the “I want to deliver for Fetch1” button 114. As we are describing from the driver's perspective, the driver next selects the “I want to deliver for Fetch1” button 114. The driver is then directed to the Stripe® login overlay 210 (FIG. 8) and Stripe welcome page 220 (FIG. 9) where he or she will sign in using their Stripe credentials, as discussed in further detail below.

FIG. 8 is an exemplary GUI of a Stripe® login overlay 210 showing the Stipe® login page which gives a user or driver access to his/her Stripe® account, according to an embodiment of the present invention. Note that FIG. 8 is a developmental mode screen shot and not the final product page as the APP is still being tested as of this writing. From the Stripe® overlay 210 the driver selects the “Connect my Stripe account” button 212.

When the driver selects the “Connect my Stripe account” button 212, the driver may be directed to the Stripe® welcome back page 220 where they fill in their Stripe credentials, namely email address 222 and password 224. FIG. 9 is an exemplary GUI of the Stripe welcome back page 220, according to an embodiment of the present invention. The driver then selects the “Sign in to your account” button 226, which allows payments to be processed into the driver's Stripe® account at the completion of deliveries. The driver is now ready to start taking deliveries using the system and method of the present invention.

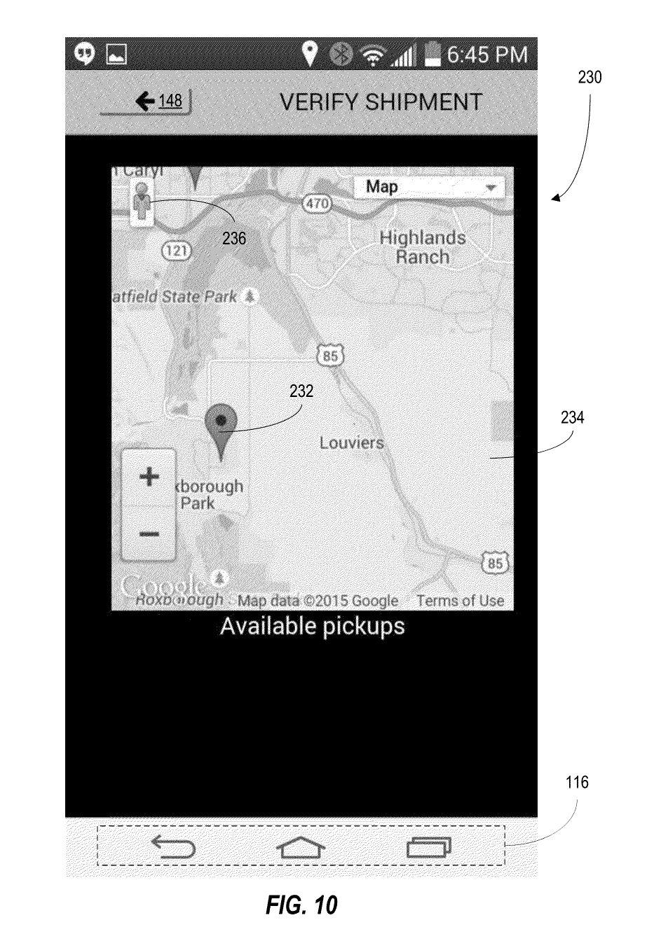

After the driver signs in with their Stripe® credentials, the driver is directed to a the available pickups page 230 showing an available pickups map 234 of the needed delivery pins 232 (one shown fully, see FIG. 10). FIG. 10 is an exemplary GUI for of an available pickups page, according to an embodiment of the present invention. According to various embodiments, the mapping software used throughout the APP may be the driver's default mapping software resident on the driver's smartphone, for example and not by way of limitation, Google Maps®, Apple Maps®, TomTom®, Garmin®, MapQuest® or any other suitable mapping software that can be ported to a smartphone and embedded in the APP as described herein. For the purposes of discussion only, Google Maps®, is the default mapping software described and shown herein. In the embedded mapping software, i.e., Google Maps®, the driver can see one or more available needed delivery pins 232 on the map 234. According to one embodiment, the driver can also see his own location by locating a driver location icon 236 located on map 234.

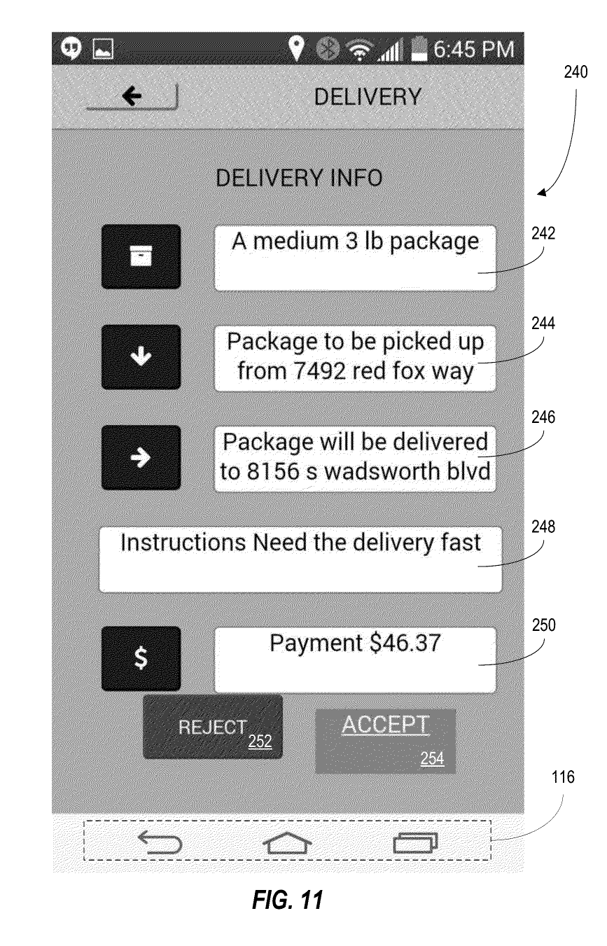

The driver then selects a needed delivery pin, for example pin 232. Once a needed delivery pin 232 is selected, the driver is directed to a delivery information page 240, see FIG. 11. FIG. 11 is an exemplary GUI for of deliver information page 240, according to an embodiment of the present invention. The delivery information page 240 displays the verified delivery information previously entered by a user wanting a package delivered. The information displayed may include the size and weight in pounds of the package 242, the pickup address 244, the delivery address 246, optional special instructions 248, and the payment amount 250.

The driver also has the option to accept or reject this particular delivery by either selecting the ACCEPT button 254, or the REJECT button 252. If the driver rejects the delivery by selecting the REJECT button 252, the driver is directed back to the available pickups page 230 (see, FIG. 10) of the APP where needed delivery pins 232 (see, FIG. 10) are again displayed on the available pickups map 234 (see, FIG. 10).

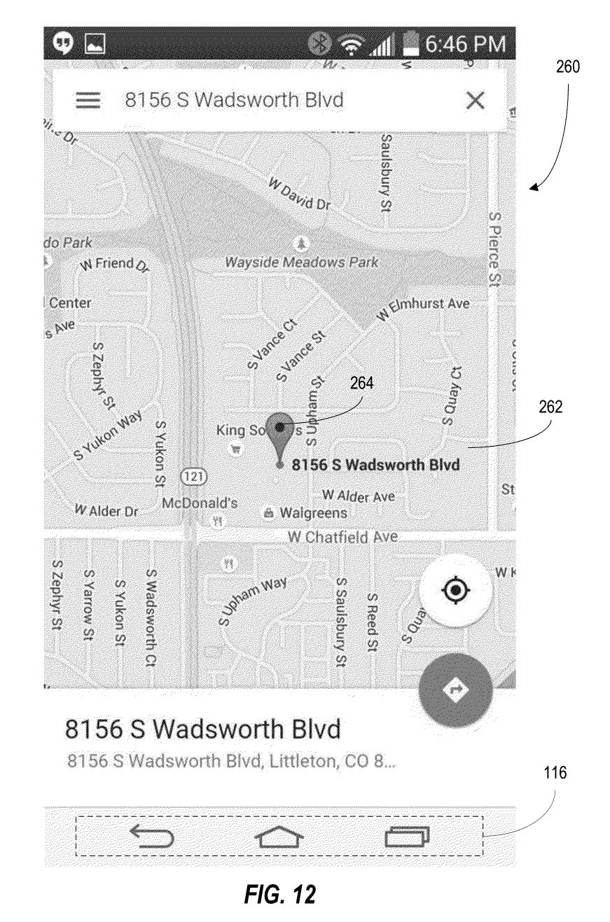

If the driver accepts the delivery by selecting the ACCEPT button 254 (FIG. 11), the driver is directed to the default mapping software in their smartphone to get directions to: (1) the pickup location, and (2) the delivery location, see FIG. 12. FIG. 12 is an exemplary GUI illustrating a driver navigation page 260, according to an embodiment of the present invention. FIG. 12 shows an exemplary driver navigation map 262 with a delivery address pin 264. Once the driver delivers the package, the driver will gather and post a signature or photo confirming delivery of the package. This signature or photo will trigger a message confirming delivery back to the user, will release the funds from escrow to the driver minus APP usage fees, and driver is directed to a rating page (not shown, but similar to rating page 190, FIG. 7). In the rating page (not shown) the driver has the option to rate the APP, or rate the user, or rate both, or rate neither and exit the APP by selecting a “NO THANKS” button (like 196, FIG. 7), according to various embodiments of the present invention.

If the driver selects the “NO THANKS” button (not shown, but like 196, FIG. 7), the driver is directed back to the Welcome page 110, FIG. 2 in the APP. If the driver desires to leave one or more ratings, they can select the desired rating on a scale ranging from one to five as desired. Again, the rating system is based on a scale from one being poor up to five being outstanding. Once the driver selects the desired rating, he or she then selects the “RATE” button (not shown, but like 198, FIG. 7), and the driver is directed back to the Welcome page 110, FIG. 2.

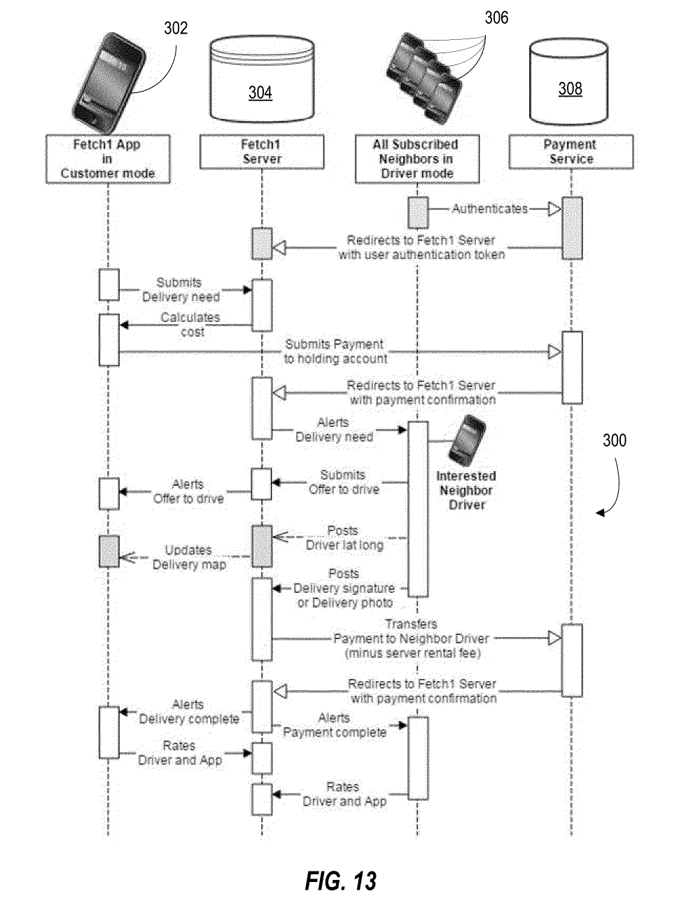

FIG. 13 is an information flow diagram, shown generally at arrow 300, illustrating how a particular embodiment of the system 300 of the present invention operates. The left-hand column beginning at the top of the page represents the user 302 of the system in customer mode. It will be understood that there can be more than one user of the system in customer mode, even though only one is shown graphically. The next column from the left beginning at the top of the page represents the Fetch 1 server 304. The next column from the left beginning at the top of the page represents the subscribed drivers 306. It will be understood that there may be one or more subscribed drivers 306 using the system. The column on the right beginning at the top of the page represents a generic payment processor 308. As noted herein, any suitable payment service may be used. Stripe® (stripe.com) is the exemplary payment processing service described herein.

The information flow in system 300, FIG. 13, will now be described from roughly top to bottom. Each of the subscribed drivers 306 must set up and authenticate a payment processing 308 account. Once the authentication is complete a user authentication token may be sent back the Fetch 1 server 304. A user 302 initiates delivery of a package by submitting a delivery need to the Fetch 1 server 304. The Fetch 1 server 304 calculates the cost of delivery and sends it back to the user 302. If the user 302 decides to move forward and engage the system 300, he or she submits payment to a holding account at the payment processor 308. Once payment is verified and held, the payment processor 308 redirects to the Fetch 1 server 304 with payment confirmation. The Fetch 1 server 304 then alerts all subscribed drivers 306 of the delivery need. One of the subscribed drivers 306 may submit an offer to drive which is submitted to the Fetch 1 server 304. That offer to drive is passed on to the user 302. Once the subscribed driver submits the offer to drive, his or her location information is continuously sent to the Fetch 1 server 304 and in turn passed to the user 302 for viewing in real time on a map on the user's smartphone. Once the subscribed driver 306 completes the delivery, he or she obtains confirmation in the form of a signature or delivery photo, which is forwarded to the Fetch 1 server 304. The confirmation triggers authorization from the Fetch 1 server 304 to the payment processor 308 to make payment to the subscribed driver's account, less a Fetch 1 server fee which is deposited into a Fetch 1 merchant account. Once the payment processor 308 has completed the payments, the Fetch 1 server 304 is sent payment confirmation. The Fetch 1 server 304 then alerts the user 302 and the subscribed driver 306 of the completed delivery and prompts both the rate the APP and the driver or user as the case may be. The rating portion is optional.

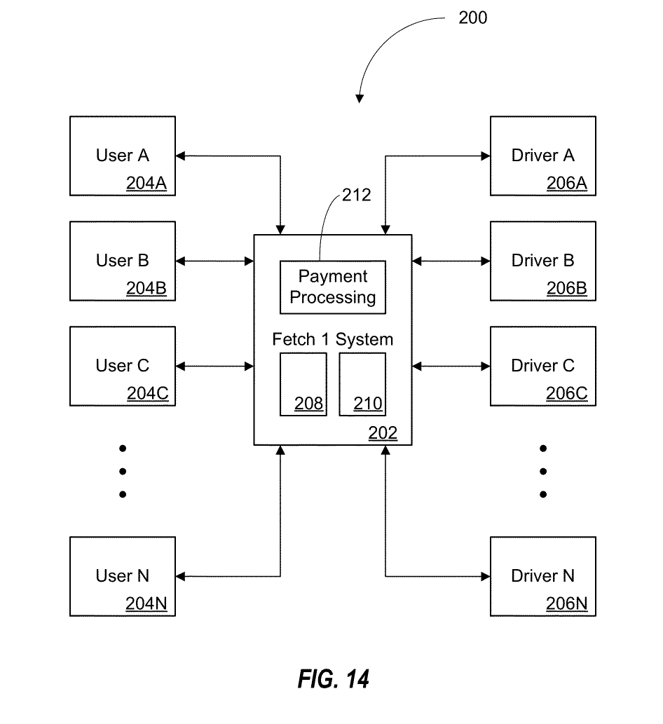

FIG. 14 is a block diagram of a generic embodiment of a system 200 for on-demand transportation of parcels according to the present invention. System 200 may include a plurality of users, 204A-204N, interacting with the Fetch 1 system 202. System 200 may further include a plurality of subscribed drivers, 206A-206N, also interacting with the Fetch 1 system 202. The Fetch 1 system 202 may include a Fetch 1 server 208 and associated Fetch 1 server software 210, a payment processing server 212 all of which are capable of communication through cellular voice and data networks, the Internet or both. The cellular voice and data networks may be offered by any of a number of commonly available cellular service providers, for example and not by way of limitation, Verizon®, AT&T®, T-Mobile®, etc. Each user 204A-204N and each driver 206A-206N has a smartphone with the Fetch 1 APP installed, and also a Navigation or Mapping (Nav) APP installed.

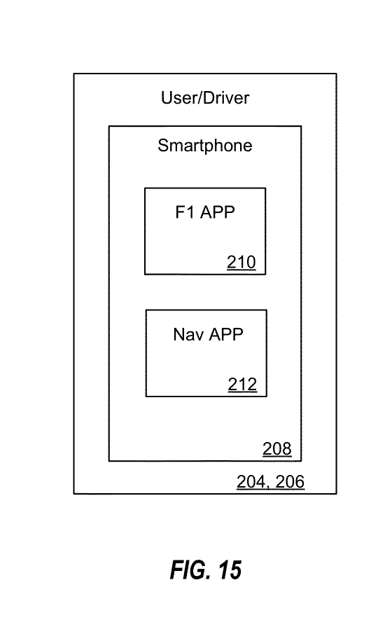

FIG. 15 is a block diagram of a generic user/driver 204, 206 according to an embodiment of the present invention. The user 204 or driver 206 has a smartphone 208, configured for running the F1 APP 300 and at least one navigation (Nav) APP 302. The APPS 300 and 302 may be stored in computer memory and computer instructions for execution by an embedded processor within the smartphone 208 as is well known. The F1 APP 300 codifies the method described herein for execution from the smartphone under control of the user 204 or driver 206. The Nav APP 302 may be called by the F1 APP 300 where display of pickup address, delivery address, driver location and needed delivery pins are to be displayed.

Additional particular embodiments of the invention will now be described with or without reference to the drawing FIGS. An embodiment of a method for on-demand delivery of parcels is disclosed. The method may include providing a server with server software configured for communicating with smartphones. The method may further include providing downloadable application software for installation and execution on the smartphones. The method may further include a subscribed driver having downloaded and installed the application software on a driver smartphone. The method may further include a user having downloaded and installed the application software on a user smartphone.

The method may further include the user initiating a request to deliver a parcel having delivery particulars where the request is sent to the server. The method may further include the server alerting the subscribed driver of the request to deliver the parcel, its delivery particulars and cost to deliver. The method may further include the subscribed driver accepting the request to deliver the parcel. The method may further include the subscribed driver retrieving the parcel from a pickup address. The method may further include the subscribed driver delivering the parcel to the delivery address. The method may further include the subscribed driver providing proof of delivery to the server. The method may further include the server alerting the user that the parcel has been delivered. The method may further include the user acknowledging delivery of the parcel. The method may further include the server making payment to the subscribed driver.

According to another embodiment, the delivery particulars may include parcel size, parcel weight, pickup address, delivery address, and optional special instructions. According to yet another embodiment the delivery particulars are precisely the following: parcel size, parcel weight, pickup address, delivery address and parcel description. According to still another embodiment the server alerting the subscribed driver of the cost to deliver may include calculating the shortest drivable distance between the pickup address and the delivery address. According to still yet another embodiment the server alerting the subscribed driver of the request to deliver the parcel may include the application software generating a map indicating location of an available pickup address and subscribed driver location. According to another embodiment, the user initiating a request to deliver a parcel having delivery particulars may further include the application software providing a graphical means for selecting parcel size. According to one particular embodiment the graphical means for selecting parcel size may include three buttons on a GUI for selecting one of small, medium and large size parcel.

An embodiment of a system for on-demand delivery of parcels is disclosed. The system may include a server having associated server software installed and running. The server may be configured for communicating with mobile smartphones through at least one cellular data network. The system may further include a user smartphone having associated application software installed, running and in communication with the server. The system may further include a plurality of driver smartphones each having the associated application software installed, running and in communication with the server. The system may further include a payment processor in communication with the server, user smartphone and the plurality of driver smartphones and the payment processor configured for verifying, holding and dispersing user payments from a user to associated driver accounts and a server merchant account.

The system may further include the user smartphone being configured to gather delivery particulars for a delivery need and to submit the particulars to the server. The system may further include the server being configured to calculate a cost of delivery and return the cost of delivery to the user smartphone. The system may further include the user smartphone being configured to submit payment based on the cost of delivery to a holding account at the payment processor. The system may further include the payment processor being configured to advise the server of the user payment having been submitted. The system may further include the server being configured to alert the plurality of driver smartphones regarding: (1) the delivery need, (2) the delivery particulars and (3) the payment for delivery.

The system may further include one of the plurality of driver smartphones submitting to the server an offer to drive. The system may further include the server alerting the user smartphone of the offer to drive. The system may further include the one of the plurality of driver smartphones continuously posting driver smartphone location to the server. The system may further include the server updating driver location information and sending same to the user smartphone. The system may further include the user smartphone configured to display the location of the driver, the pickup address and delivery address for viewing. The system may further include the one of the plurality of driver smartphones posting a delivery signature or delivery photo to the server to confirm delivery. The system may further include the server configured to authorize the payment processor to make payment for delivery. The system may further include the payment processor being configured to pay the driver account for delivery, less a server fee placed in the server merchant account and the payment processor confirming payments made to the server. The system may further include the server being configured to alert the user smartphone of delivery completion.

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. The terms “parcel” and “package” are used synonymously and refers to the item(s) being delivered using the system and method of the present invention without regard for size. Finally, terms of degree such as “substantially”, “about” and “approximately” as used herein mean a reasonable amount of deviation of the modified term such that the end result is not significantly changed.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A method for on-demand delivery of parcels, comprising:
providing a server with server software configured for communicating with smartphones;
providing downloadable application software for installation and execution on the smartphones;
a subscribed driver having downloaded and installed the application software on a driver smartphone;
a user having downloaded and installed the application software on a user smartphone;
the user initiating a request to deliver a parcel having delivery particulars, the request sent to the server;
the server alerting the subscribed driver of the request to deliver the parcel, its delivery particulars and cost to deliver;
the subscribed driver accepting the request to deliver the parcel;
the subscribed driver retrieving the parcel from a pickup address;
the subscribed driver delivering the parcel to the delivery address;
the subscribed driver providing proof of delivery to the server;
the server alerting the user that the parcel has been delivered;
the user acknowledging delivery of the parcel; and
the server making payment to the subscribed driver.

2. The method according to claim 1, wherein the delivery particulars comprise: parcel size, parcel weight, pickup address, delivery address, and optional special instructions.

3. The method according to claim 1, wherein the delivery particulars are consisting of: parcel size, parcel weight, pickup address and delivery address.

4. The method according to claim 3, wherein the server alerting the subscribed driver of the cost to deliver comprises calculating the shortest drivable distance between the pickup address and the delivery address.

5. The method according to claim 1, wherein the server alerting the subscribed driver of the request to deliver the parcel further comprises the application software generating a map indicating location of an available pickup address and subscribed driver location.

6. The method according to claim 1, wherein the user initiating a request to deliver a parcel having delivery particulars further comprises the application software providing a graphical means for selecting parcel size.

7. The method according to claim 6, wherein the graphical means for selecting parcel size comprises three buttons on a graphical user interface for selecting one of small, medium and large.

8. A system for on-demand delivery of parcels, comprising:
a server having associated server software installed and running, the server configured for communicating with mobile smartphones through at least one cellular data network;
a user smartphone having associated application software installed, running and in communication with the server;
a plurality of driver smartphones each having the associated application software installed, running and in communication with the server;
a payment processor in communication with the server, user smartphone and the plurality of driver smartphones, the payment processor configured for verifying, holding and dispersing user payments from a user to associated driver accounts and a server merchant account;
the user smartphone configured to gather delivery particulars for a delivery need and submit the particulars to the server;
the server configured to calculate a cost of delivery and return the cost of delivery to the user smartphone;
the user smartphone configured to submit payment based on the cost of delivery to a holding account at the payment processor;
the payment processor configured to advise the server of the user payment submitted;
the server configured to alert the plurality of driver smartphones regarding the delivery need, delivery particulars and payment for delivery;
one of the plurality of driver smartphones submitting to the server an offer to drive;
the server alerting the user smartphone of the offer to drive;
the one of the plurality of driver smartphones continuously posting driver smartphone location to the server;
the server updating driver location information and sending same to the user smartphone;
the user smartphone configured to display the location of the driver, the pickup address and delivery address for viewing;
the one of the plurality of driver smartphones posting a delivery signature or delivery photo to the server;
the server configured to authorize the payment processor to make payment for delivery;
the payment processor configured to pay the driver account for delivery, less a server fee placed in the server merchant account and the payment processor confirming payments made to the server; and
the server configured to alert the user smartphone of delivery completion.
